(19) United States
(12) Patent Application Publication
(10) Pub. No.: US 2007/0058189 A1
(43) Pub. Date: Mar. 15, 2007

(54) Image forming apparatus and image forming method

(75) Inventor: Minoru Yaguchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/337,241

(22) Filed: Jan. 20, 2006

(30) Foreign Application Priority Data
Sep. 12, 2005 (JP) JP2005-264096

(51) Int. Cl. G06F 3/12

(52) U.S. Cl. 358/1.13; 358/1.15

(57) ABSTRACT

An image processing apparatus and an image processing method, which can determine the optimal copy conditions at the time of preparing printed material from the read out document without depending on image analysis, are provided. When forming images on a sheet, the attribution information and the status information (the print information) of the document whose image is formed on the sheet are written in the information recording medium attached to that sheet. At the time of preparing an printed material by reading this sheet as a new document, the print information is obtained from the information recording medium of that sheet, and the optimal set values related to the copy conditions of the printed material, such as the positions of staples, etc., are determined and displayed or set.

### RELATED APPLICATION

This application is based on Japanese Patent Application No. 2005-264096 filed on Sep. 12, 2005, in Japanese Patent Office, the entire content of which is hereby incorporated by reference.

### BACKGROUND

1. Technical Field

The present invention relates to image forming apparatuses of preparing printed material based on read out documents.

2. Description of the Related Art

In image forming apparatuses such as copying machines, the user can make various types of settings at the time of copying such as providing margins, enlarging or reducing images sizes, reducing several pages of document to fit in one page of copying sheet, etc. In addition, when providing a post image processing apparatus that carries out finishing operations on sheets after image forming such as punching holes, folding, stitching by stapling, etc., even the various settings related to post image processing will have to be made by the user when necessary.

In particular, regarding the settings related to the position of stapling, the orientation of the sheet or the orientation of the text, etc need to betaken into consideration and were complicated and easy to make errors in. In view of this, a technology has been proposed (see, for example, Patent Document 1) that rotates the image if necessary so that the stapling position is always at the top left of the sheet by reading the document and judging the orientation of the text.

Further, there are apparatuses in which the staple position is determined by judging the orientation of the first page of the document and of the text and, if necessary, rotating the images of the second and subsequent pages to match with that stapling position (see, for example, Patent Document 2), or equipment that grasp the orientation of the text in the document and the orientation of the recording paper and determine the angle of rotation of the images and the stapling position accordingly (see, for example, Patent Document 3).

Patent Document 1: Japanese Unexamined Patent Application Open to Public Inspection No. 8-181853

Patent Document 2: Japanese Unexamined Patent Application Open to Public Inspection No. 10-133521

Patent Document 3: Japanese Unexamined Patent Application Open to Public Inspection No. 2001-27865

However, in each of the technologies disclosed in the above Patent Documents, since the stapling position is determined by judging the orientation of the text from the read out document, it was not possible to use this function in the case of documents that did not have any text. In addition, there were cases of wrongly judging the orientation. of text in the case of special characters such as pictographic characters.

In addition, since the stapling position determined from the result of judging the orientation of text in the document is always determined at the same position as long as the same document is read in, when wanting to set a different stapling position, it was inconvenient because it was necessary every time to manually change the setting of the automatically determined stapling position.

Further, there was the problem that, when copying a document, although it is possible to make the setting of margins, the enlargement or reduction setting, or the N-in-1 setting of reducing a plurality of pages and fitting them in one page, if the operator does not realize that the original document itself was prepared under these conditions, it is possible that the margin is set twice thereby making the margin unnecessarily large, or an N-in-1 setting is made for an already N-in-1 document thereby making the images excessively reduced. Further, in the method of analyzing the image of the document, since it is not possible to correctly recognize the contents of the settings made at the time of preparing the document, it was not possible to issue to the user appropriately a warning that the margin has been set twice, etc.

### SUMMARY

A purpose of the present invention is to provide an image processing apparatus that, without depending on image analysis, can determine the optimal copy conditions at the time of preparing a printed material from the read out document.

Further, another purpose of the present invention is to provide an image forming apparatus and an image forming method that, when carrying out image forming based on the document and preparing the printed material, can reduce the operation load for reproducing the copy conditions set arbitrarily by the user, and that can judge whether or not the copy conditions set arbitrarily by the user are appropriate based on the past copy conditions.

In view of foregoing, an object of this invention is to solve at least one of the problems, and to provide new apparatus. The apparatus comprises

an information recording section which records print information to an information recording medium, wherein a first printed material is produced by forming a first image on a first recording sheet based on the print information;

an image reading section which reads the first image on the first recording sheet with the information recording medium storing the print information;

an information obtaining section which obtains the print information from the information recording medium on the first recording sheet; and

a determination section which determines first copy conditions based on the print information, wherein a second printed material is produced by forming a second image on a second recording sheet based on the first copy conditions and the first image on the first recording sheet.

According to another aspect of the present invention, the apparatus comprises

an information recording section which records print information to an information recording medium, wherein a first printed material is produced by forming a first image on a first recording sheet based on the print information;

an image reading section which reads the first image on the first recording sheet with the information recording medium storing the print information;

an information obtaining section which obtains the print information from the information recording medium on the first recording sheet; and

a display section which displays the print information.

According to another aspect of the present invention, the apparatus comprises

an information recording section which records print information to an information recording medium, wherein a first printed material is produced by forming a first image on a first recording sheet based on the print information;

an image reading section which reads the first image on the first recording sheet with the information recording medium storing the print information;

an information obtaining section which obtains the print information from the information recording medium on the first recording sheet;

a user setting section which accepts user's setting for copy conditions, wherein a second printed material is produced by forming a second image on a second recording sheet based on the copy conditions and the first image on the first recording sheet; and

a judging section which judges whether the copy conditions set by the user setting section are appropriate.

According to another aspect of the present invention, the apparatus comprises

an image reading section which reads a first image on a first recording sheet with an information recording medium storing print information, wherein a first printed material is produced by forming the first image on the first recording sheet based on the print information;

an information obtaining section which obtains the print information from the information recording medium on the first recording sheet; and

a determination section which determines first copy conditions based on the print information, wherein a second printed material is produced by forming a second image on a second recording sheet based on the first copy conditions and the first image on the first recording sheet.

The invention itself, together with further objects and attendant advantages, will best be understood by reference to the following detailed description taken in conjunction with the accompanying drawings.

### BRIEF DESCRIPTION OF THE DRAWINGS

FIG. 1 is a block diagram showing the configuration of an image forming system that includes an image forming apparatus according to a preferred embodiment of the present invention.

FIG. 2 is a block diagram showing the configuration of an image forming apparatus according to a preferred embodiment of the present invention.

FIG. 3(a) is an explanatory diagram showing an example of the data structure of the print information stored in an RFID tag attached to the recording sheet.

FIG. 3(b) is an explanatory diagram showing an example of the data of the print information stored in an RFID tag attached to the recording sheet.

FIG. 4 is a flow diagram showing the processing of the first-time operations of forming images on a sheet by an image forming apparatus according to a preferred embodiment of the present invention.

FIG. 5 is a flow diagram showing the processing of the operations of preparing a printed material by reading the sheet on which an image forming was done using the processing shown in FIG. 4 as a new document in an image forming apparatus according to a preferred embodiment of the present invention.

FIG. 6 is a flow diagram showing in detail the condition comparison processing in FIG. 5.

FIG. 7 is an explanatory diagram showing an example of the optimal position display screen that is displayed in the operation and display section.

FIG. 8 is an explanatory diagram showing an example of the position selection display screen that is displayed in the operation and display section.

FIG. 9 is an explanatory diagram showing an example of the duplicate margin setting warning display screen that is displayed in the operation and display section.

In the following description, like parts are designated by like reference numbers throughout the several drawings.

### DETAILED DESCRIPTION OF THE PREFERRED EMBODIMENT

A preferred embodiment of the present invention is described below with reference to the drawings.

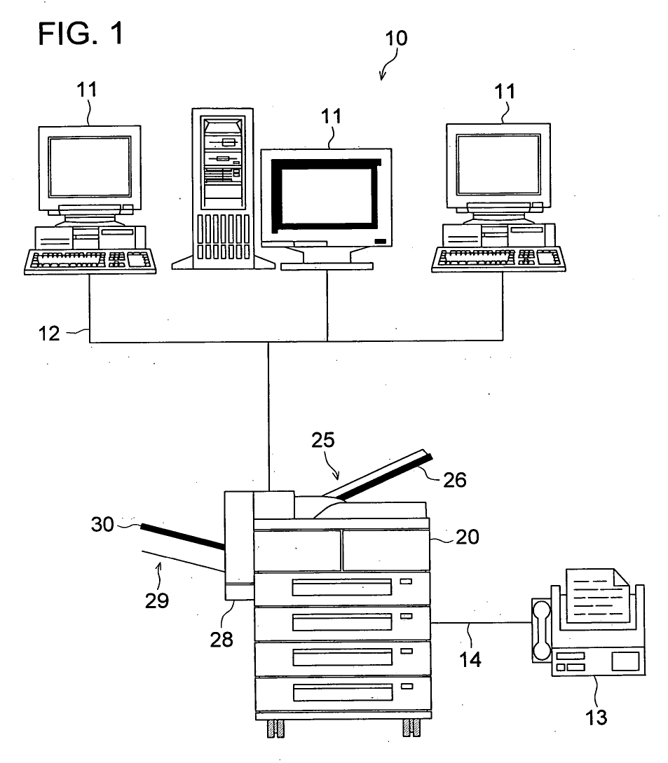

FIG. 1 is a block diagram showing the configuration of an image forming system 10 that includes an image forming apparatus 20 according to a preferred embodiment of the present invention. The image forming apparatus 20 is configured as a so-called digital multi function peripheral provided with the copying function of forming on sheets (recording sheets) the images obtained by reading out the document, the printing function of forming images on sheets based on the received image data, and the facsimile function of transmitting and receiving image data. External terminals such as a personal computer 11 are connected to the image forming apparatus 20 via a LAN 12 (Local Area Network). In addition, facsimile equipment 13 is connected via communication lines such as public switched telephone network lines 14.

The image forming apparatus 20, at the time of outputting a sheet after forming images on it, writes the print information at the time of image forming into the information recording medium attached to the sheet, and thereafter, at the time of reading that sheet as a new original document the print information is read out from the information recording medium of that sheet, and utilizes the print information for setting the copy conditions related to image forming or post image processing. In the present preferred embodiment, an electronic tag of the RFID (Radio Frequency Identification) method (hereinafter referred to as RFID tag) is used as the information recording medium.

Here, the print information is information that indicates what kind of images are formed on the sheet in what kind of settings, and it includes the attribution information and the status information of the document printed of the sheet. For example, the attribution information can be information indicating the size of the document, the set values of the margins at the time of image forming, the orientation of images and text characters, enlargement or reduction setting, the format (settings of N-in-1, etc.), information indicating whether or not the document is two-sided, etc. The document status information of the document is not the information indicating the nature related to the document itself, but is the environmental information related to the condition of placing the document such as whether it was placed horizontal or vertical (portrait or landscape type of placement) when the document was read out. Apart from this, it is possible to write as print information the copy conditions set at the time of carrying out image forming on the sheet, and including conditions related to post image processing, etc.

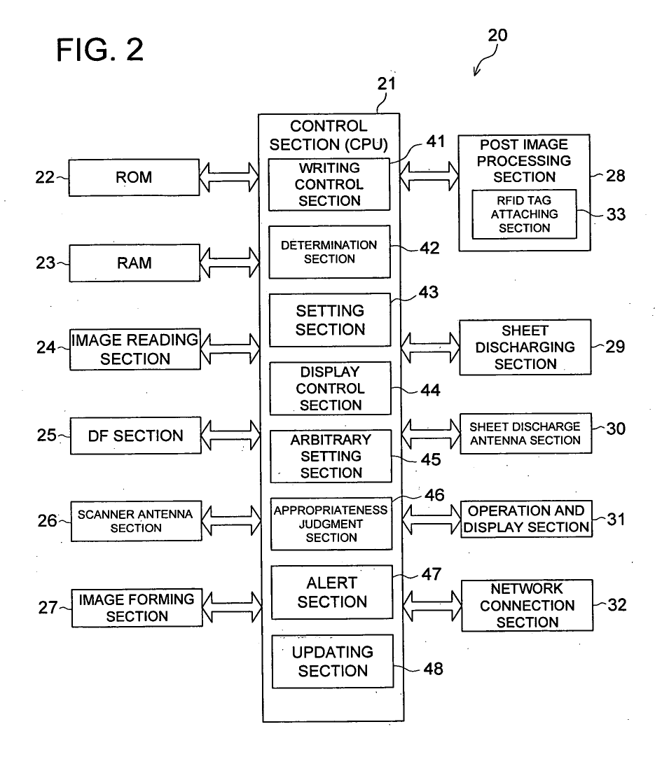

FIG. 2 is a block diagram showing the electrical configuration of the image forming apparatus 20.

The image forming apparatus 20 has a control section 21 that comprehensively controls the operation of this apparatus. This control section 21 is configured using a CPU (Central Processing Unit). A ROM (Read Only Memory) 22, RAM (Random Access Memory) 23, an image reading section 24, a document feeder (DF) section 25, a scanner antenna section 26, an image forming section 27, a post image processing section 28, a sheet discharging section 29, a sheet discharge antenna section 30, an operation and display section 31, and a network connection section 32 are connected to the control section 21.

ROM 22 stores the programs executed by the control section 21 and various types of fixed data. The RAM 23 functions as a working storage that temporarily stores various types of data at the time of program execution by the control section 21, and functions as a page memory that temporarily stores image data.

The image reading section 24 carries out the function as an image reading section that reads the document and takes in the corresponding image data. The image reading section 24 is provided with a light source that illuminates the document, a line image sensor that reads one line of the document along its width direction, a movement section that moves the reading position in units of a line along the length direction of the document, and an optical path comprising lenses and mirrors that guide and focus the reflected light from the document to the line image sensor. The line image sensor is configured using a CCD (Charge Coupled Device). The analog video signal output by the line image sensor is A/D converted and is output as a digital image data.

The DF section 25 carries out the function of conveying successively the document sheets placed on the document loading section of this DF section 25. Further, the document loading section is provided with a sensor not shown in the figure for obtaining information (document loading information) indicating the orientation, size, etc., of the loaded document.

A scanner antenna section 26 is placed in the neighborhood of the DF section 25 (see FIG. 1). The scanner antenna section 26 carries out the role as an information obtaining section that, at the time the image of the document is being read by the image reading section 24, reads and obtains print information from the RFID tag attached to the document, and has an antenna for carrying out non-contacting communication with the RFID tag of the document. Further, the scanner antenna section 26 is also provided with the function of writing information in to the RFID tag attached to the document.

The image forming section 27 carries out the function of forming and outputting the image corresponding to the image data on sheets by an electro-photographic process. The image forming section 27 is configured as a so-called laser printer that comprises a sheet conveying unit, a photoreceptor drum, a charging unit, a laser unit, a development unit, a transferring and separating unit, a cleaning unit, and a fixing unit.

The post image processing section 28 has the function of carrying out various types of post image processing operations on the sheets discharged from the image forming section 27. For example, it carries out the folding operation of center-folding the sheets or folding the sheets in three parts, the stapling operation of stitching by stapling a plurality of sheets, the punching operation of punching holes in the sheets, etc. Because of this, for example, the sheets with images formed on them are bound into a booklet. When there is no post image processing specification, the sheets output from the image forming section 27 pass through the post image processing section 28 without any operation being done on them and are discharged by the sheet discharging section 29.

Further, the post image processing section 28 has an RFID tag attaching section 33. The RFID tag attaching section 33 has the function of attaching an RFID tag to sheets with no RFID tag attached to them. Here, an RFID antenna, not shown in the figure, is placed in the sheet feeding path, a judgment is made as to whether or not the fed sheet has an RFID tag attached to it, and the attaching operation is executed if no RFID tag has been attached to the sheet. Further, the location of placement of the RFID tag attaching section 33 need not be restricted to the location shown in the figure but can be any appropriate position within the conveying path.

The sheet discharging section 29 has the role of stacking the sheets discharged from the post image processing section 28. A sheet discharge antenna section 30 is provided in the neighborhood of the sheet discharging section 29 (see FIG. 1). The sheet discharge antenna section 30 carries out the function of a information recording section that writes print information into the RFID tag, and is provided with an antenna for carrying out non-contacting communication with the RFID tag attached to the sheet. The timing of writing information into the RFID tag attached to the sheet can be when it passes the post image processing section 28 or can also be when the sheet is discharged over the sheet discharging section 29.

The operation and display section 31 is configured to comprise a liquid crystal display provided with a touch panel on its surface and various types of operation switches and has the functions of displaying to the user various types of guidance information and status information, and of receiving various types of instructions from the user.

The network connection section 32 has the function of communicating with external apparatuses via the LAN 12 or the public switched telephone network lines 14.

The control section 21, apart from carrying out comprehensive control of the operations of this apparatus, is provided with the functions of a writing control section 41, a determination section 42, a setting section 43, a display control section 44, an arbitrary setting section 45, an appropriateness judgment section 46, a warning section 47, and an updating section 48, and carries out the control for reducing the work load on the user related to making the settings for image forming and post image processing using the print information.

The writing control section 41 carries out, at the time of forming images on a sheet, control of writing the print information in the RFID tag of that sheet using the sheet discharge antenna section 30.

The determination section 42 carries out the function of judging the optimal values of the copy conditions at the time of preparing the printed material from that document, based on the print information obtained from the RFID tag of the document at the time of reading that document. The copy conditions are the various conditions (the set values etc. of setting items) related to the preparation of the printed material, and include the conditions at the time of image forming and the conditions of post image processing operations. The conditions at the time of image forming are the copy conditions related to the formation of images on recording sheets such as the copy conditions of the margin settings or the N-in-1 setting, the size and orientation of the sheet, the angle of rotation of the images, etc. The post image processing conditions indicate, for example, the conditions of folding, stitching, punching holes, etc. The optimal values of the copy conditions are the recommended conditions of the apparatus. Further, at the time of judging the optimal values of the copy conditions, it is also good to consider the information related to the functions and attribution information of the image forming apparatus that is currently preparing the printed material from the document.

For example, when the stapling function has been selected, the orientation of the image in the document is acquired from the print information, and a judgment, such as “the optimum stapling position is ‘top left’ of the sheet” is made from this information and the orientation of the sheets (recording sheets).

The setting section 43 has the function of setting the optimal values of the copy conditions determined in the determination section 42 as the copy conditions at the time of preparing the printed material from the document read in the image reading section 24.

The display control section 44 carries out the function of displaying in the operation and display section 31 the optimal values of the copy conditions determined in the determination section 42.

The arbitrary settings section 45 carries out the function of accepting the settings, related to the copy conditions at the time of preparing the printed material, arbitrarily made by the user from the user via the operation and display section 31. The user-made settings can also be accepted from an external terminal via a communication link.

The appropriateness judgment section 46 carries out the function of judging, based on the print information obtained from the RFID tag of the document, the appropriateness of the copy conditions arbitrarily set by the user using the setting section 43.

The warning section 47 carries out the function of issuing a warning to the user, when the result of judgment of the appropriateness judgment section 46 indicates inappropriateness, informing the user of that inappropriateness. Here, the warning display is made via the operation and display section 31. An inappropriate setting is, for example, the user making a duplicate 4-in-1 setting when the document has already been prepared with a 4-in-1 setting, or the user making a duplicate margin setting when a margin setting has already been made for the document.

The updating section 48 carries out the function of writing in the RFID tag of the document the optimal values of the copy conditions judged by the writing control section 41 or the copy conditions arbitrarily set by the user (hereinafter referred to also as user-made settings) etc. as additional or rewritten print information. The writing is done using the scanner antenna section 26.

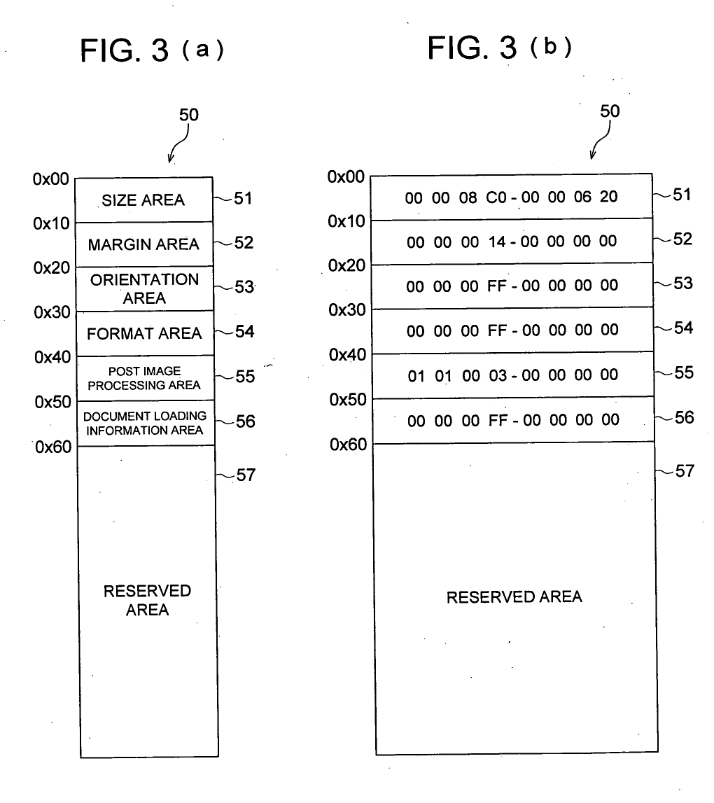

FIG. 3 shows an example of the data structure and data of the print information stored in an RFID tag. In the storage area of the RFID tag are provided, from the beginning, a size area 51, a margin area 52, an orientation 53, a format area 54, a post image processing area 55, a document loading information area 56, and a reserved area 57.

The length along the main scanning direction and the length along the auxiliary scanning direction of the image of the document formed on the sheet are registered in the size area 51. In the actual example of FIG. 3(b), the two values “08 C0” and “06 20” have been written in the size area 51, where “08 C0” indicates that the length along the main scanning direction is 224.0 mm, and “06 20” indicates that the length along the auxiliary scanning direction is 156.8 mm.

Values indicating the size of the margins set at the time image forming was done on the sheet are registered in the margin area 52. In the actual example of FIG. 3(b), the two values “14” and “00” have been written, where “14” indicates that a margin of 20.0 mm has been set along the horizontal direction and “00” indicates that a margin of 0 mm has been set along the vertical direction.

A value indicating whether the image formed on the sheet is of horizontally written or vertically written text is registered in the orientation area 53. In the actual example of FIG. 3(b), the value “FF” indicates that the image is of horizontally written text. This value will be “00” in the case of vertically written text.

A value indicating the type of format that was set at the time image forming was done on the sheet is registered in the format area 54. A format setting can be the setting of a booklet, an N-in-1 setting, or a repeat setting of repeatedly placing the same image several times in-one sheet, etc. In the actual example of FIG. 3(b), the value “FF” indicates that the booklet setting has been made.

The information related to post image processing that had been set at the time image forming was done on the sheet is registered in the post image processing area 55. In the actual example of FIG. 3(b), the value “01 01 00 03” has been registered, in which the first value “01” indicates that the sheet is horizontally oriented, the next value “01” indicates that stapling operation has been set, and the last value “03” indicates that the stapling position is the bottom left position. By changing these values, it is possible to indicate that the sheet is vertically oriented or the stapling position is top right, etc.

The placement information indicating the orientation in which the document with images formed on it was placed in the DF section 25 is registered in the document loading information area 56. In the actual example of FIG. 3(b), the value “FF” indicates that the document had been placed horizontally.

The reserved area 57 has been prepared for registering other information. Here, the information indicating the optimal values of the copy conditions judged by the writing control section 41, information indicating the copy conditions set by the user (user-made settings) using the arbitrary settings section 45, etc. are registered in this area. Further, the data structure or the contents of data registered in the RFID tag need not be limited to the example shown above, land it is sufficient if any necessary information is registered in a readable manner.

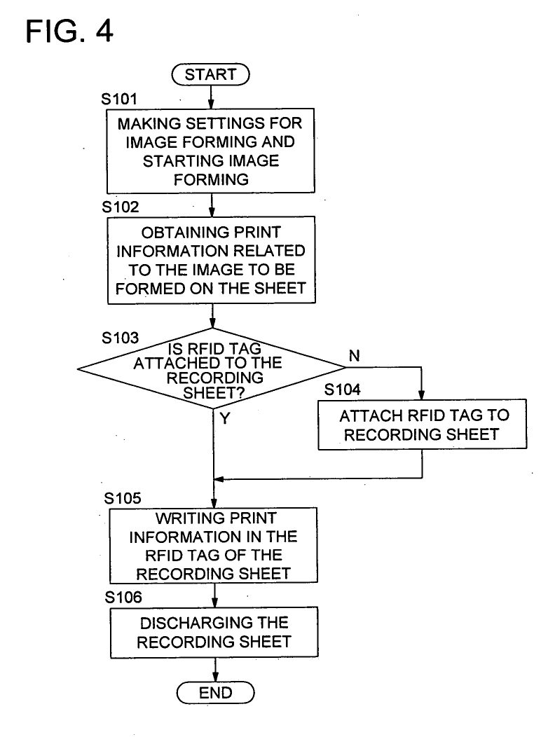

FIG. 4 shows the flow of the first-time operations of forming images on a sheet by the image forming apparatus 20. When the start button is operated after the document has been placed by the user on the loading section of the DF section 25 and the copy conditions related to image forming and post image processing have been set, the image forming apparatus 20 starts the image forming operations according to the copy conditions that have been set (Step S101). Next, the print information of the attribution information or the status information of the document from which image forming has to be done on the sheet is obtained (Step S102). In other words, the information indicating the set values related to orientation and size of the document placed on the document loading section of the DF section 25, the margin settings made by the user via the operation and display section 31, the orientation of the image (horizontally written or vertically written), the format, etc., and the set values regarding post image processing is acquired as the print information.

Next, a judgment is made as to whether or not an RFID tag has been attached to the sheet (recording sheet) that has been conveyed (Step S103), if an RFID tag has already been attached (Y in Step S103), the print information is written into the RFID tag of that sheet in the sheet discharge antenna section 30 (Step S105). On the other hand, if an RFID tag has not been attached (N in Step S103), after an RFID tag is attached to the sheet in RFID tag attaching section 33 (Step S104), the print information is written into this attached RFID tag (Step S105). Thereafter, the sheet to which has been attached an RFID tag in which print information has been written is discharged to the sheet discharge section 29 (Step S106), and the first-time image processing operation is completed (END). Further, the judgment whether it is a first-time image processing operation or not can be made by judging whether or not print information has already been written in the RFID tag of the document.

In the above processing, although print information was written in the RFID tag of the sheet after an RFID tag has been attached to the sheet in the RFID tag attaching section 33, it is also possible to first write information into the RFID tag and then attach that RFID tag to the corresponding sheet.

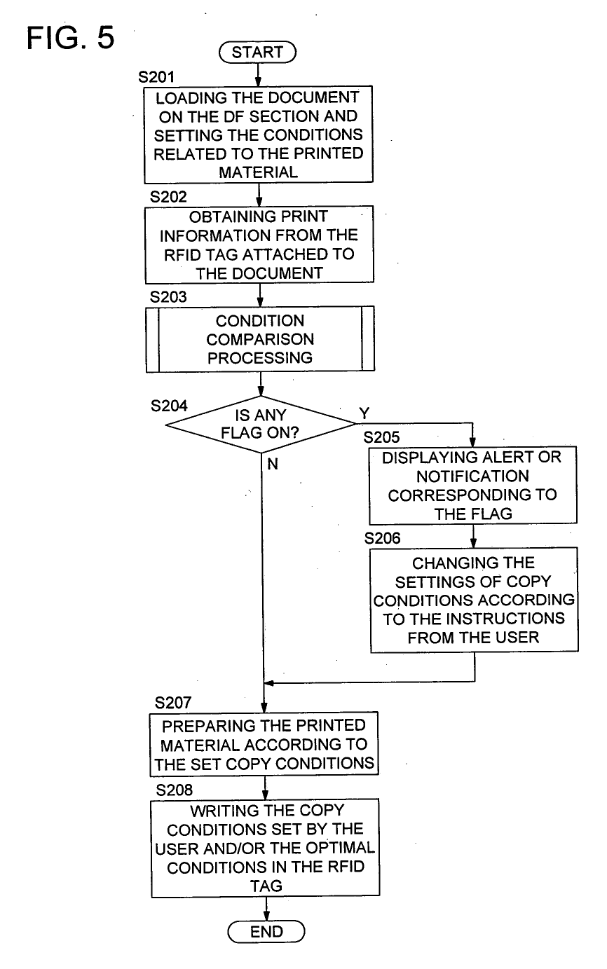

FIG. 5 shows the flow of the processing of preparing a printed material by reading the sheet on which image forming was done using the processing shown in FIG. 4 as a new original document in an image forming apparatus 20.

When the user operates the start button after placing the sheet on which image forming has been done as a new document on the loading section of the DF section 25 and after setting the copy conditions related to image forming or post image processing when preparing an printed material such as a booklet from that document (Step S201), the image forming apparatus 20 obtains the print information from the RFID tag attached to the document placed on the DF section 25 (Step S202). In addition, if information indicating the copy conditions arbitrarily set by the user (user-made settings) or the information indicating the optimal values of the copy conditions determined previously in the determination section 42 has been written in the RFID tag, such information is also obtained at the same time.

Next, the condition comparison processing of judging the optimal values of the copy conditions based on the print information obtained from the RFID tag of the document or judging the appropriateness of the copy conditions set by the user this time is executed (Step S203). Although the details of the condition comparison processing will be described later, in this processing, when if there is any inappropriate item in the copy conditions set by the user or if it is necessary to display some notification screen or a warning screen to the user, a flag indicating this fact is set.

In the condition comparison processing, a check is made of whether any flag has been made ON (Step S204), if there is any flag that is ON (Y in Step S204), a notification screen or a warning screen corresponding to the flag is displayed in the operation and display section 31 (Step S205). In these screens, an instruction of changing the copy conditions or an instruction of forced execution as it is from the user is accepted (Step S206), and the operation of preparing the printed material according to the copy conditions instructed by the user is executed (Step S207). Thereafter, the copy conditions instructed finally by the user during the operation this time are written into the RFID tag of the document (Step S208), and the processing is terminated (END). Further, it is also possible to write in the RFID tag of the document both the optimal values of the copy conditions determined by the determination section 42 and the copy conditions instructed by the user, or else, it is possible to write them both only when there is a difference in the optimal values of the copy conditions and the copy conditions set by the user.

Although in the above example the optimal values of the copy conditions are displayed after the start button is pressed, it is also possible to display the optimal values of the copy conditions after acquiring the print information at the point when the document is set in the document loading section of the DF section 25.

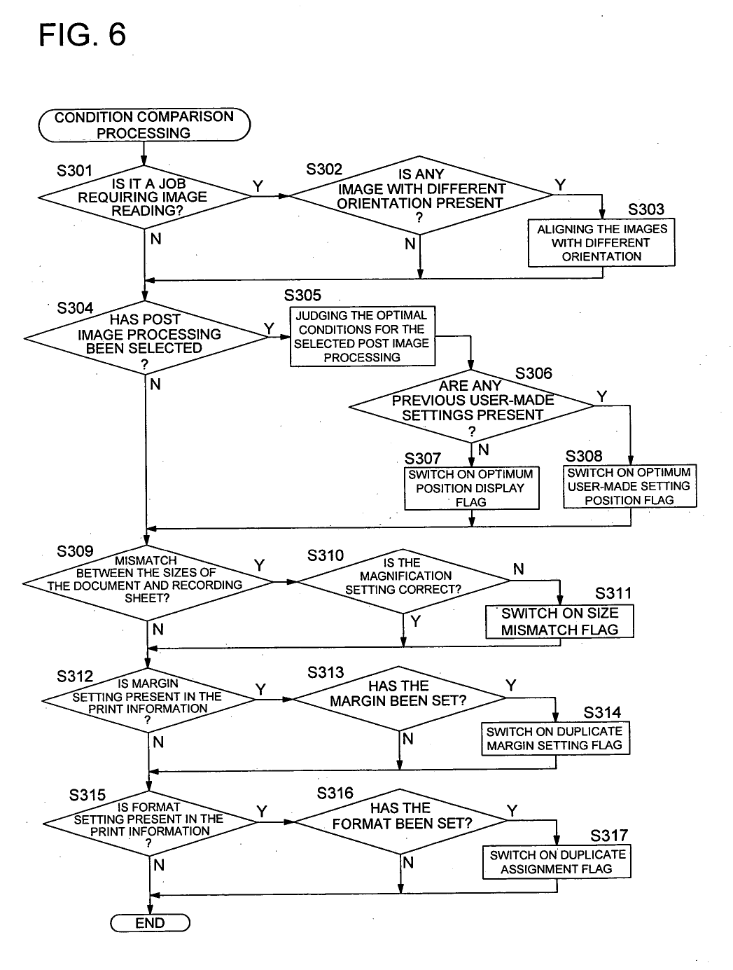

FIG. 6 shows the flow of the condition comparison processing of FIG. 5. In the condition comparison processing, a plurality of conditions are judged successively. To begin with, a judgment is made as to whether or not the job to be executed is a job that includes reading operation by the image reading section 24 (Step S301), and if the job does not include an image reading operation (N in Step S301), the processing proceeds to the next condition judgment (Step S304).

In the case of a job that includes the image reading operation (Y in Step S301), a check is made of whether or not there are images with different orientations in the document loaded in the DF section 25 (Step S302), and the processing proceeds to the next condition judgment (Step S304) if there are no image with different orientations (N in Step S302).

When there are images with different orientations (Y in Step S302), the images with different orientations are rotated, and after all the images are aligned so that they have the same orientation (Step S303), the processing proceeds to the next condition judgment (Step S304). In other words, since the orientation information of the image is present in the print information read out from the RFID tag of the document, the orientation of the image is judged from this orientation information and the placement information obtained from a sensor not shown in the figure but provided in the DF section 25, and all images are aligned so that they have the same orientation.

Further, at this point, since the image of the document has not yet been read, the information related to alignment is retained as it is and actual rotation is made after the images are read. In addition, the condition judgment processing can also be carried out after the images of the documents have been read out and stored in the memory.

The judgment of said next condition is that of judging whether the user has selected post image processing or not (Step S304), and the processing proceeds to the next condition judgment (Step S309) if post image processing has not been selected (N in Step S304). On the other hand, if post image processing has been selected (Y in Step S304), the optimal condition related to the selected post image processing is judged and obtained from the print information obtained from the RFID tag of the document and the orientation and size of the sheet that can be fed in that apparatus, and the functions and attributes of the post image processing apparatus (Step S305).

Furthermore, a check is made if information indicating the conditions set by the user in the past relating to the same post image processing operation as the selected post image processing operation is present or not in the obtained print information (Step S306), the optimum position indication flag is made ON (Step S307) if it is not present (N in Step S306), and if it is present (Y in Step S306), the optimum/user setting position indication flag is made ON (Step S308). The optimum position indication flag being ON indicates that the optimal post image processing conditions judged by the apparatus should be displayed in the notification screen, and the optimum/user setting position indication flag being ON indicates that the optimal post image processing conditions judged by the apparatus and the conditions set by the user in the past should be displayed simultaneously in the notification screen.

If any one of these flags is set, the processing proceeds to the next condition judgment (Step S309). The next condition judgment is that of judging whether the document size information indicated by the print information obtained from the RFID tag of the document agrees with the sheet size used in the current image forming or not (Step S309). If the sizes match (N in Step S309), the processing proceeds to the next condition judgment (Step S312).

If the sizes do not match (Y in Step S309), a judgment is made as to whether or not the magnification set by the user is appropriate considering the size of the document obtained from the RFID tag and the size of the sheet used for image forming (Step S310).

The processing proceeds to the next condition judgment (Step S312) if it is appropriate (Y in Step S310). If it is not appropriate (N in Step S310), the size mismatch flag is made ON indicating that the size of the sheet (recording sheet) is inappropriate with respect to the document size (Step S311), and the processing proceeds to the next condition judgment (Step S312).

In the judgment of the next condition, a decision is made as to whether or not the print information obtained from the RFID tag of the document indicates that margin setting has been completed (a value larger than 0 as the margin setting) (Step S312). If margin setting has not been completed (N in Step S312), the processing proceeds to the next condition judgment (Step S315).

If the print information indicates that margin setting has been completed (Y in Step S312), a judgment is made as to whether or not the user has made a margin setting (Step S313), the processing proceeds to the next condition judgment (Step S315) if the user has not made a margin setting (N in Step S313), and if the user has made a margin setting (Y in Step S313), the duplicate margin setting flag is made ON indicating that the margin setting has been made twice (Step S314), after which the processing proceeds to the next condition judgment (Step S315).

In the judgment of the next condition, a decision is made as to whether or not the print information obtained from the RFID tag of the document includes a valid format setting (Step S315). If no format setting such as an N-in-1 setting or an N-repeat setting has been made (N in Step S315), this processing is terminated (END).

If some format setting has been made (Y in Step S315), a check is made as to whether or not a duplicate format setting has been made by the user (Step S316), and the processing is terminated (END) if the user has not made a duplicate format setting (N in Step S316). If the user has made a duplicate format setting (Y in Step S316), the duplicate assignment flag is made ON (Step S317) indicating that the format setting has been made twice, and the processing is terminated (END).

Depending on the type of flag that has been made ON, various types of notification screens or warning screens are displayed in Step S205 in FIG. 5.

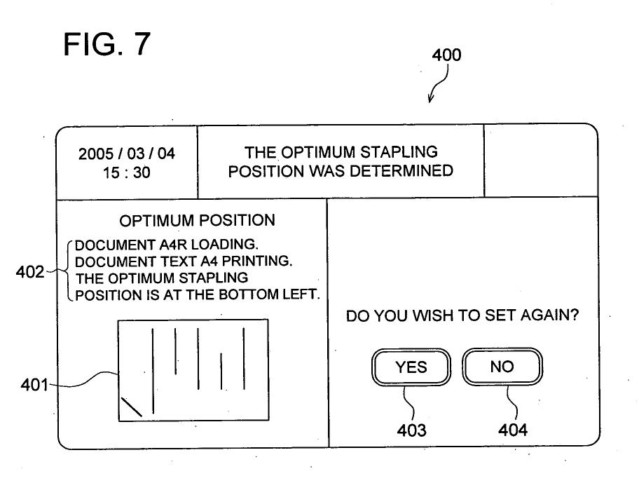

FIG. 7 is an example of the optimum position display screen 400 that is displayed in the operation and display section 31 when the optimum position display flag has been made ON. The left half of the optimum position display screen 400 shows a drawing 401 indicating the optimum stapling position which is the position recommended by the apparatus as determined by the determination section 42 based on the print information obtained from the RFID tag of the document. In addition, above that, is also displayed information 402 that was the basis for judging this optimum stapling position. The user can judge, referring to the information 402 that was the basis for judging this optimum stapling position, whether or not it is satisfactory to use the optimum stapling position recommended by the apparatus.

The “Yes” button 403 in the right half of the screen is an operation button for approving the optimum stapling position recommended by the apparatus and by operating this button 403, the optimum stapling position recommended by the apparatus gets confirmed as the stapling position at the time of preparing the printed material this time. The “No” button 404 is an operation button for denying the optimum stapling position recommended by the apparatus and by operating this button 404, either the stapling position specified by the user is adopted, or the display changes to a screen (not shown in the figure) for setting again the stapling position.

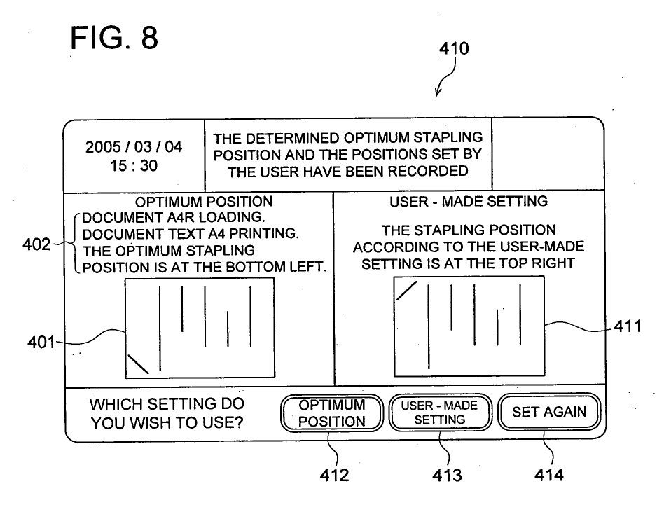

FIG. 8 is an example of the position selection screen 410 that is displayed in the operation and display section 31 when the optimum/user-set position flag is ON. The left half of the position selection screen 410 displays, similar to the optimum position display screen 400 of FIG. 7, a drawing 401 indicating the optimum stapling position which is the position recommended by the apparatus and the information 402 that was the basis for judging this optimum stapling position. A drawing 411 indicating the stapling position set by the user in the past is shown in the right half of the position selection screen 410. The stapling position set by the user in the past is displayed based on the information related to user settings in the print information obtained from the RFID tag attached to the document. Because of this, the user can compare the optimum stapling position recommended by the apparatus with the stapling position set by the user in the past.

The “Optimum position” button 412 in the lowermost part of the screen is an operation button for approving the optimum stapling position recommended by the apparatus and by operating this button 412, the optimum stapling position recommended by the apparatus gets confirmed as the stapling position at the time of preparing the printed material this time. The “User setting” button 413 is an operation button for selecting the stapling position set by the user in the past. The “Set again” button 414 is an operation button for selecting a different stapling position, and when this button 414 is operated, the display changes to a screen (not shown in the figure) for setting again the stapling position. When the stapling position is set again, that stapling position set newly will be written in the RFID tag of the document as a new user set position by adding or updating the contents of the tag.

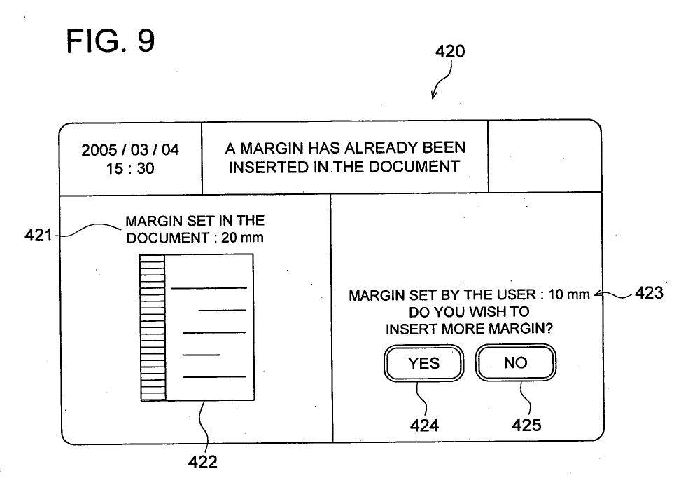

FIG. 9 is an example of the duplicate margin setting warning display screen 420 that is displayed in the operation and display section 31 when the duplicate margin setting flag has been made ON. The left half of the duplicate margin setting warning display screen 420 shows the set value of the margin 421 obtained from the margin area 52 of the RFID tag attached to the document and a drawing 422 showing the sheet in the state in which that margin has been given. The set value 423 the margin set this time by the user is displayed in the right half of the screen 420, and below that are displayed the “Yes” button 424 and the “No” button 425. When the “Yes” button 424 is operated, a value equal to the sum of the margin set originally for the document and the margin set by the user is taken as the set value of the margin. When the “No” button 425 is operated, the duplicate margin setting is aborted, and only the margin value set originally for the document is used as the set value of the margin.

Apart from this, similarly, even when the duplicate assignment flag has been made ON, a warning screen not shown in the figure is displayed that compares the state in which the original format set for the document is used with the state in which the format set by the user is superimposed on this, and the user can select whether to abort the duplicate format setting or to carry out the job with the duplicate setting left as it is.

In the above, although a preferred embodiment of the present invention was described with reference to the drawings, the concrete configuration need not be limited to that shown in the preferred embodiment, and any additions or modification within a range not deviating from the scope and intent of the present invention shall be included in the present invention.

Further, although in the preferred embodiment, information was written in the RFID tag by the sheet discharge antenna section 30 of the image forming apparatus 20, it is also possible to have a configuration in which the print information is transmitted to another apparatus from the image forming apparatus and the print information is written in the RFID tag in that other apparatus.

Although in the preferred embodiment the scanner antenna section 26 and the sheet discharge antenna section 30 were provided separately, it is possible to have a configuration in which the two functions are shared by a single antenna.

Further, in order to distinguish individual documents in the state in which a plurality of documents have been placed on the loading section, for example, it is good to utilize the identification numbers in the RFID tags since unique identification numbers have been registered in the RFID tags. The document with which identification number corresponds to which page number can be judged, for example, by detecting the identification number that could not be detected in the scanner antenna section 26 while the documents are being fed out one sheet at a time in the DF section 25, and by judging that the document with that identification number is the document that was fed out last. Of course, it is also possible to provide a separate antenna that detects the RFID tags of documents after they have been fed out.

In the preferred embodiment, although, in the position selection screen 410, the optimum stapling position and the stapling position set by the user and obtained from the RFID tag were displayed side by side, it is also possible to display them in two separate screens. In addition, when there are several types of stapling positions set by the user and obtained from the RFID tag, it is also possible to have a configuration in which the several types of stapling positions are displayed either alongside or in separate screens so that the desired stapling position can be selected from among these different types of stapling positions. The same is true also for other conditions and without restricting this only to the stapling position.

Further, although in the preferred embodiment the print information was written in the RFID tags of all the sheets on which image forming was carried out, it is possible, for example, to write the print information only in the RFID tags on the leading sheet or on some of the sheets. Because of this, it is possible to reduce the processing load and the time required for writing in the RFID tags. In addition, when attaching RFID tags to sheets, it is also possible to reduce the processing load and the time required for that operation.

Although in the preferred embodiment the case was described in which the document is read out in the image reading section 24 and image forming is done during the first-time image forming, for example, in a similar manner, even when carrying out image forming from the print data received via a network, it is possible to write the print information at the time of that image forming in the RFID tag of the sheet. Further, in the above preferred embodiment, an example was described in which the attribution information, the status information, and the information related to post image processing were used as the print information, it is also possible to have configurations in which any of them is used or a combination of any two of them are used.

Further, in the present invention, apart from recording sheets on which image forming has been done, the printed material can also be booklets, etc. which have recording sheets only which post image processing operations such as hole punching or stitching have been done. The copy conditions are the conditions related to the preparation of the printed material, and include the conditions at the time of image forming and the conditions of post image processing operations. The conditions at the time of image forming are the copy conditions related to the formation of images on recording sheets such as the copy conditions of the margin settings or the N-in-1 setting, the size and orientation of the sheet, the angle of rotation of the images, etc. The post image processing conditions indicate, for example, the conditions of folding, stitching, punching holes, etc. The optimal values of the copy conditions are the recommended conditions of the apparatus.

In addition, the copy conditions (for example, the stapling position etc.) set at the time of image forming for the first time can be written further in the RFID tags of sheets, and next, at the time that one such sheet is read out as a new document, these copy conditions can be obtained from the RFID tag attached to that sheet, and these copy conditions can be displayed or can be set automatically.

Although in the above preferred embodiment, the judgment of optimal values of the copy conditions and the judgment of appropriateness of the settings made by the user were both carried out, it is possible to carry out only one of these judgments. For example, it is possible to have a configuration in which only the judgment of the appropriateness of the settings made by the user this time is made based on the print information obtained from the RFID tag. According to the preferred embodiment of the present invention, the print information (the attribution information related to the document or the status information) at the time of carrying out image forming on the sheet (the first recording sheet) and preparing the printed material is written in the information recording medium that is attached to or is to be attached later to said first recording sheet. The timing of writing information can be optional, and for example, it is good to write the information related to the document at the time of carrying out image forming. Thereafter, at the time of reading this sheet as a new document, the print information is obtained from the information recording medium attached to that sheet, and based on the print information so obtained, the copy conditions are determined at the time of carrying out image forming on a second recording sheet and preparing the printed material by taking this sheet as a new document.

The print information includes the attribution information related to the document and the status information. The attribution information related to the document is information that indicates what kind of images are stored in what kind of format in the sheet, such as, for example, this can be information indicating the size of the document, the set values of the margins at the time of image forming, the orientation of images and text characters, enlargement or reduction setting, the format (settings of N-in-1, etc.), information indicating whether or not the document is two-sided, etc. In other words, the document can be not only the document that is read out by a scanner, etc., but can be image of the entire sheet prepared in a page memory, etc., at the time of carrying out image forming on the sheet and includes margin settings or N-in-1 setting, etc.

The document status information of the document is not the information indicating the nature related to the document itself, but is the information related to the condition of placing the document such as whether it was placed horizontal or vertical (portrait or landscape type of placement) when the document was read out in a scanner. Such print information can merely be the information that becomes the basis for judging the optimum values of copy conditions at the time of using the first recording sheet with image forming on it done as a new document and preparing the printed material or for judging whether or not the copy conditions set by the user are appropriate, and are not the copy conditions themselves that are set at the time of preparing the printed material using that sheet as a new document.

A printed material includes, apart from a recording sheet on which image forming has been done, booklets comprising recording sheets that have been subjected to finishing operations such as punching, stitching, etc. The copy conditions are the conditions related to the preparation of the printed material, and include the conditions at the time of image forming and the conditions of post image processing operations. The conditions at the time of image forming are the copy conditions related to the formation of images on recording sheets such as the copy conditions of the margin settings or the N-in-1 setting, the size and orientation of the sheet, the angle of rotation of the images, etc. The post image processing conditions indicate, for example, the conditions of folding, stitching, punching holes, etc. The optimal values of the copy conditions are the recommended conditions of the apparatus.

According to another aspect of the preferred embodiment of the present invention, the copy conditions determined by the determination section are set automatically as the copy conditions at the time of preparing an printed material by taking the read out sheet as a new document. Since the copy conditions are set automatically, it is possible to eliminate the cumbersome task of making the settings. Further, it is possible either to carry out or not to carry out the operations of preparing the printed material using the copy conditions so set.

According to another aspect of the preferred embodiment of the present invention, the copy conditions determined by the determination section are further written in the information recording medium of the first recording sheet. At the time of using the first recording sheet as a document again it is possible to use the result of judgment this time as it is.

According to another aspect of the preferred embodiment of the present invention, the copy conditions of the previous time are obtained from the information recording medium attached to the first recording sheet, and these are displayed and/or are set as the copy conditions at the time of preparing the printed material by carrying out image forming on a third recording sheet based on the images of said first recording sheet. Because the copy conditions of the previous time can be obtained, it is not necessary to carry out the judgment of the copy conditions all over again in the determination section regarding the preparation of the printed materials during the current time.

According to another aspect of the preferred embodiment of the present invention, the copy conditions that are determined by the determination section are displayed in the display section. From this display, it is possible for the user to judge whether or not the copy conditions determined by the apparatus (the recommended conditions) are satisfactory.

According to another aspect of the preferred embodiment of the present invention, the copy conditions set at the time of carrying out image forming on a second recording sheet are written in the information recording medium attached to the first recording medium, and after that writing is done, when using that first recording sheet as a new document, the copy conditions that were set at the time of carrying out image forming on the second recording sheet are obtained from that information recording medium and displayed. The copy conditions can be displayed separately from the copy conditions that were determined by the determination section, or can be displayed simultaneously with the determined copy conditions so that it becomes easy to compare them.

According to another aspect of the preferred embodiment of the present invention, it is possible to set arbitrarily the copy conditions that are different from the copy conditions determined by the determination section. The method of setting the conditions arbitrarily can be either the method of making changes while taking the determined copy conditions as the basis or the method of making new settings starting from the beginning.

According to another aspect of the preferred embodiment of the present invention, whether or not said copy conditions that have been arbitrarily set by the user are appropriate is judged based on the print information obtained from the information recording medium attached to the sheet, and a warning is given if they are not appropriate. In other words, since it is possible to obtained, from the information recording medium attached to the sheet, the information related to the orientation of the image on the sheet or the margin settings, the N-in-1 setting, etc., a judgment is made as to whether these and the settings arbitrarily made by the user are appropriate or not, and a warning is given if there are any impropriety such as duplicate margin settings, etc. Because of this, it is possible to prevent the printed material being wastefully output due to not being aware of improper values of the copy conditions.

According to another aspect of the preferred embodiment of the present invention, the copy conditions arbitrarily set by the user are written in the information recording medium of the first recording sheet taking it as a new document. Because of this, at the time of reading that sheet taking it as a document next time, it is possible to use the copy conditions that were arbitrarily set by the user this time.

According to another aspect of the preferred embodiment of the present invention, the copy conditions arbitrarily set by the user are obtained from the information recording medium attached to the first recording medium, these are displayed, and/or set as the copy conditions at the time of preparing the printed material by carrying out image forming on a third recording sheet taking the first recording sheet as a new document. Since the copy conditions that were set the previous time by the user can be obtained, it is not necessary for the user to make the settings again for the current printed material.

According to another aspect of the preferred embodiment of the present invention, the print information at the time image forming was carried out on the first recording sheet is obtained from the information recording medium attached to that sheet and is displayed. For example, apart from the orientation of the images on the sheet, information related to margin settings, or to N-in-1 setting, which is difficult to judge using image analysis, are displayed, and it is possible to prevent making improper settings such as duplicate margin settings without realizing these.

According to another aspect of the preferred embodiment of the present invention, the print information at the time image forming was carried out on the first recording sheet is obtained from the information recording medium attached to that sheet and the appropriateness of the copy conditions set by the user is judged based on the obtained information. For example, judgment is made as to whether or not a duplicate margin setting is made due to margin settings having been made by the user. A warning may be issued when the settings are not appropriate. Further, the copy conditions need not to be obtained.

According to another aspect of the preferred embodiment of the present invention, the conditions related to sheeting finishing operations are included in the copy conditions for preparing the printed material. For example, these are conditions related to the presence or absence of stapling operation, punching operation of making holes in the sheets, booklet operation of folding the sheets and binding them into the shape of a booklet, the stapling position, the stitching position, etc.

According to the image forming apparatus of the preferred embodiment of the present invention, since the print information at the time of carrying out image forming on that sheet is written in the information recording medium attached to that sheet, and since the print information is obtained from the information recording medium attached to that sheet when that sheet is read in taking it as a new document, unlike in the case of using image analysis at the time of acquiring the print information, there is no limitation on the information that can be obtained nor there is no possibility of the information not being recognized depending on the contents of the image, but it is possible to obtain a variety of information related to the document such as the status of margin settings, etc. without incorrect recognition, and can be utilized for finding and setting the copy conditions for preparing the printed material taking that sheet as a new document.

In particular, since the copy conditions are determined on the apparatus side based on the print information obtained from the information recording medium, and since the copy conditions obtained by such judgment are set automatically, the load of the user for finding out and setting the copy conditions gets reduced thereby improving the convenience of use.

Further, in case that the appropriateness of the copy conditions arbitrarily set by the user is judged based on the information obtained from the information recording medium, and that a warning is given when they are not appropriate, it is possible to prevent the preparation of the printed materials with clearly abnormal settings.

In case that the copy conditions arbitrarily set by the user are written in the information recording medium, it is possible to obtain the copy conditions that were arbitrarily set in the past and use them at the time of using that sheet next as a document, it is possible to reduce the load of operation of making the settings of the copy conditions desired by the user. It is to be noted that various changes and modifications will be apparent to those skilled in the art. Therefore, unless such changes and modifications depart from the scope of the present invention, they should be construed as being included therein.

What is claimed is:

1. An image forming apparatus, comprising:
an information recording section which records print information to an information recording medium, wherein a first printed material is produced by forming a first image on a first recording sheet based on the print information;
an image reading section which reads the first image on the first recording sheet with the information recording medium storing the print information;
an information obtaining section which obtains the print information from the information recording medium on the first recording sheet; and
a determination section which determines first copy conditions based on the print information, wherein a second printed material is produced by forming a second image on a second recording sheet based on the first copy conditions and the first image on the first recording sheet.

2. The image forming apparatus of claim 1, further comprising:
a setting section which sets the first copy conditions, wherein a second printed material is produced by forming a second image on a second recording sheet based on the first copy conditions and the first image on the first recording sheet.

3. The image forming apparatus of claim 1, wherein the information recording section records the first copy conditions to the information recording medium on the first recording sheet.

4. The image forming apparatus of claim 3, wherein the information obtaining section obtains the first copy conditions from the information recording medium on the first recording sheet, and the setting section sets second copy conditions,
wherein a third printed material is produced by forming a third image on a third recording sheet based on the second copy conditions and the first image on the first recording sheet.

5. The image forming apparatus of claim 1, further comprising:
a display section which displays the first copy conditions.

6. The image forming apparatus of claim 5, wherein the information recording section records the first copy conditions to the information recording medium on the first recording sheet, the information obtaining section obtains the first copy conditions from the information recording medium when the image on the first recording sheet is read by the image reading section, and the display section displays the first copy conditions.

7. The image forming apparatus of claim 1, wherein the first copy conditions include conditions relating to an image forming process.

8. The image forming apparatus of claim 1, wherein the first copy conditions include conditions relating to a post image processing.

9. The image forming apparatus of claim 1, further comprising:
an operation and display section which accepts arbitrary setting for copy conditions, wherein a second printed material is produced by forming a second image on a second recording sheet based on the copy conditions accepted by the operation and display section and the first image on the first recording sheet.

10. The image forming apparatus of claim 9, further comprising:
a judging section which judges whether the copy conditions arbitrarily set by the operation and display section are appropriate, and
an alert section which alerts in case that the copy conditions are inappropriate.

11. The image forming apparatus of claim 10, wherein the information recording section records the copy conditions arbitrarily set by the operation and display section.

12. The image forming apparatus of claim 11, wherein the information obtaining section obtains the copy conditions arbitrarily set by the operation and display section from the information recording medium when the image reading section reads the first image on the first recording sheet, and the setting section sets second copy conditions,
wherein a third printed material is produced by forming a third image on a third recording sheet based on the second copy conditions and the first image on the first recording sheet.

13. The image forming apparatus of claim 9, wherein the copy conditions arbitrarily set by the operation and display section includes conditions relating to an image forming process.

14. The image forming apparatus of claim 9, wherein the copy conditions arbitrarily set by the operation and display section includes conditions relating to a post image processing.

15. An image forming apparatus, comprising:
an information recording section which records print information to an information recording medium, wherein a first printed material is produced by forming a first image on a first recording sheet based on the print information;
an image reading section which reads the first image on the first recording sheet with the information recording medium storing the print information;
an information obtaining section which obtains the print information from the information recording medium on the first recording sheet; and
a display section which displays the print information.

16. An image forming apparatus, comprising:
an information recording section which records print information to an information recording medium, wherein a first printed material is produced by forming a first image on a first recording sheet based on the print information;
an image reading section which reads the first image on the first recording sheet with the information recording medium storing the print information;
an information obtaining section which obtains the print information from the information recording medium on the first recording sheet;
a user setting section which accepts user's setting for copy conditions, wherein a second printed material is produced by forming a second image on a second recording sheet based on the copy conditions and the first image on the first recording sheet; and
a judging section which judges whether the copy conditions set by the user setting section are appropriate.

17. An image forming apparatus, comprising:
an image reading section which reads a first image on a first recording sheet with an information recording medium storing print information, wherein a first printed material is produced by forming the first image on the first recording sheet based on the print information;
an information obtaining section which obtains the pint information from the information recording medium on the first recording sheet; and
a determination section which determines first copy conditions based on the print information, wherein a second printed material is produced by forming a second image on a second recording sheet based on the first copy conditions and the first image on the first recording sheet.
